(19) United States
(12) Patent Application Publication
(10) Pub. No.: US 2024/0399590 A1
(43) Pub. Date: Dec. 5, 2024

(54) ROBOT MONITORING SYSTEM, MONITORING DEVICE, METHOD FOR CONTROLLING MONITORING DEVICE, AND NON-TRANSITORY TANGIBLE STORAGE MEDIUM

(71) Applicant: Panasonic Intellectual Property Management Co., Ltd., Osaka (JP)

(72) Inventor: Yugo NOSE, Kyoto (JP)

(21) Appl. No.: 18/798,995

(22) Filed: Aug. 9, 2024

Related U.S. Application Data
(63) Continuation of application No. PCT/JP2022/039390, filed on Oct. 21, 2022.

(30) Foreign Application Priority Data
Feb. 15, 2022 (JP) 2022-021211

(51) Int. Cl. B25J 9/16

(52) U.S. Cl. CPC B25J 9/1697; B25J 9/1674

(57) ABSTRACT

A monitoring device includes a storage, a controller, and a communication module. The storage stores a table in which a series of operation positions to which a monitoring target of a robot moves and time information regarding a timing when the monitoring target is positioned at each of the operation positions are associated with each other. The controller executes a process of determining an operational abnormality of the robot by comparing an operation position of the monitoring target acquired from the robot with an operation position of the monitoring target based on a captured image from a camera, and a process of determining an operational abnormality of the robot by comparing a timing when the operation position has been acquired from the robot with a timing based on the time information associated with the operation position in the table.

### CROSS REFERENCE TO RELATED APPLICATION

This application is a continuation of International Application No. PCT/JP2022/039390 filed on Oct. 21, 2022, entitled “ROBOT MONITORING SYSTEM, MONITORING DEVICE, METHOD FOR CONTROLLING MONITORING DEVICE, AND PROGRAM”, which claims priority under 35 U.S.C. Section 119 of Japanese Patent Application No. 2022-021211 filed on Feb. 15, 2022, entitled “ROBOT MONITORING SYSTEM, MONITORING DEVICE, METHOD FOR CONTROLLING MONITORING DEVICE, AND PROGRAM”. The disclosures of the above applications are incorporated herein by reference.

### BACKGROUND OF THE INVENTION

### Field of the Invention

The present invention relates to a robot monitoring system for monitoring operation of a robot, a monitoring device for monitoring operation of a robot, a method for controlling the monitoring device, and a non-transitory tangible storage medium having stored therein a program for causing the monitoring device to execute predetermined functions.

### Description of Related Art

To date, robots have been used in the fields of factory automation and the like. For example, a robot arm is installed near a belt conveyor. In accordance with a control command set in advance, the robot arm transfers an article placed at a predetermined position, to a container on the belt conveyor, for example.

Japanese Patent No. 6633584 describes a method for detecting occurrence of an abnormality in a robot during operation of the robot. In this method, a camera that captures an overview of the operation range of the robot is installed. An image acquired by this camera is compared with a simulation image of the robot position viewed from the camera direction. When there is a difference exceeding a predetermined amount between these two images, it is determined that an abnormality has occurred in the operation of the robot.

However, in the method above, in the imaging direction of the camera, so-called occlusion in which a hand of the robot is hidden behind an arm may occur, for example. Such occlusion is particularly likely to occur when the installation position of the camera is restricted to a certain extent, such as when an image of a plurality of robots is captured by a single camera. When such occlusion has occurred, the hand is not captured in the camera image. Therefore, even if the camera image is compared with a simulation image, an operational abnormality of the hand cannot be appropriately determined.

### SUMMARY OF THE INVENTION

A first aspect of the present invention relates to a robot monitoring system. The robot monitoring system according to this aspect includes a camera configured to capture an image of at least an operation range of a robot; and a monitoring device configured to monitor operation of the robot, based on a captured image from the camera. The monitoring device includes a storage, a controller, and a communication module configured to perform communication with the robot and the camera. The storage stores a table in which a series of operation positions to which a monitoring target of the robot moves and time information regarding a timing when the monitoring target is positioned at each of the operation positions are associated with each other. The controller executes: a first determination process of determining an operational abnormality of the robot by comparing an operation position of the monitoring target acquired from the robot via the communication module with an operation position of the monitoring target based on the captured image acquired from the camera via the communication module; and a second determination process of determining an operational abnormality of the robot by comparing a timing when the operation position has been acquired from the robot via the communication module with a timing based on the time information associated with the operation position in the table.

In the robot monitoring system according to the present aspect, an operational abnormality of the robot can be determined through the first determination process using a captured image of the robot. Even when occlusion of the monitoring target of the robot has occurred in this captured image, an operational abnormality of the robot can be determined through the second determination process using the time information regarding the timing when the monitoring target is positioned at each of the operation positions. Therefore, an operational abnormality of the robot can be determined appropriately and assuredly.

A second aspect of the present invention relates to a monitoring device configured to monitor operation of the robot. The monitoring device according to this aspect includes a storage, a controller, and a communication module configured to perform communication with the robot and a camera configured to capture an image of at least an operation range of the robot. The storage stores a table in which a series of operation positions to which a monitoring target of the robot moves and time information regarding a timing when the monitoring target is positioned at each of the operation positions are associated with each other. The controller executes: a first determination process of determining an operational abnormality of the robot by comparing an operation position of the monitoring target acquired from the robot via the communication module with an operation position of the monitoring target based on a captured image acquired from the camera via the communication module; and a second determination process of determining an operational abnormality of the robot by comparing a timing when the operation position has been acquired from the robot via the communication module with a timing based on the time information associated with the operation position in the table.

A third aspect of the present invention relates to a method for controlling a monitoring device configured to monitor operation of a robot. In the method for controlling the monitoring device according to this aspect, the monitoring device stores a table in which a series of operation positions to which a monitoring target of the robot moves and time information regarding a timing when the monitoring target is positioned at each of the operation positions are associated with each other. The method for controlling the monitoring device includes the steps of: acquiring an operation position of the monitoring target from the robot via a communication module; acquiring a captured image via the communication module from a camera configured to capture an image of at least an operation range of the robot; determining an operational abnormality of the robot by comparing the operation position of the monitoring target acquired from the robot with an operation position of the monitoring target based on the captured image acquired from the camera; and determining an operational abnormality of the robot by comparing a timing when the operation position has been acquired from the robot with a timing based on the time information associated with the operation position in the table.

A fourth aspect of the present invention relates to a non-transitory tangible storage medium having stored therein a program configured to cause a controller, of a monitoring device configured to monitor operation of a robot, to execute predetermined functions. The program according to this aspect includes a table in which a series of operation positions to which a monitoring target of the robot moves and time information regarding a timing when the monitoring target is positioned at each of the operation positions are associated with each other. The program causes the controller to execute: a function of acquiring an operation position of the monitoring target from the robot via a communication module; a function of acquiring a captured image via the communication module from a camera configured to capture an image of at least an operation range of the robot; a function of determining an operational abnormality of the robot by comparing the operation position of the monitoring target acquired from the robot with an operation position of the monitoring target based on the captured image acquired from the camera; and a function of determining an operational abnormality of the robot by comparing a timing when the operation position has been acquired from the robot with a timing based on the time information associated with the operation position in the table.

According to the second to fourth aspects above, effects similar to those of the first aspect above can be exhibited.

The effects and the significance of the present invention will be further clarified by the description of the embodiment below. However, the embodiment below is merely an example for implementing the present invention. The present invention is not limited to the description of the embodiment below in any way.

### BRIEF DESCRIPTION OF THE DRAWINGS

FIG. 1 schematically shows a use form of a robot monitoring system according to an embodiment;

FIG. 2 is a block diagram showing configurations of a robot arm, a camera, and a monitoring device according to the embodiment;

FIG. 3 shows a configuration of a table stored in a storage of the monitoring device according to the embodiment;

FIG. 4 schematically shows a relationship between the field of view of the camera and a rectangular coordinate system of the robot arm according to the embodiment;

FIG. 5 is a flowchart showing a process performed by a controller during actual operation of the robot arm according to the embodiment;

FIG. 6 is a flowchart showing a monitoring process performed in the controller of the monitoring device according to the embodiment;

FIG. 7 is a flowchart showing another monitoring process performed in the controller of the monitoring device according to the embodiment;

FIG. 8 shows a configuration of a table stored in the storage of the monitoring device according to a modification;

FIG. 9 is a flowchart showing a monitoring process performed in the controller of the monitoring device according to the modification;

FIG. 10 schematically shows a use form of the robot monitoring system 1 according to another modification; and

FIG. 11 is a flowchart showing a monitoring process performed in the controller of the monitoring device according to another modification.

It is noted that the drawings are solely for description and do not limit the scope of the present invention in any way.

### DETAILED DESCRIPTION

Hereinafter, an embodiment of the present invention will be described with reference to the drawings.

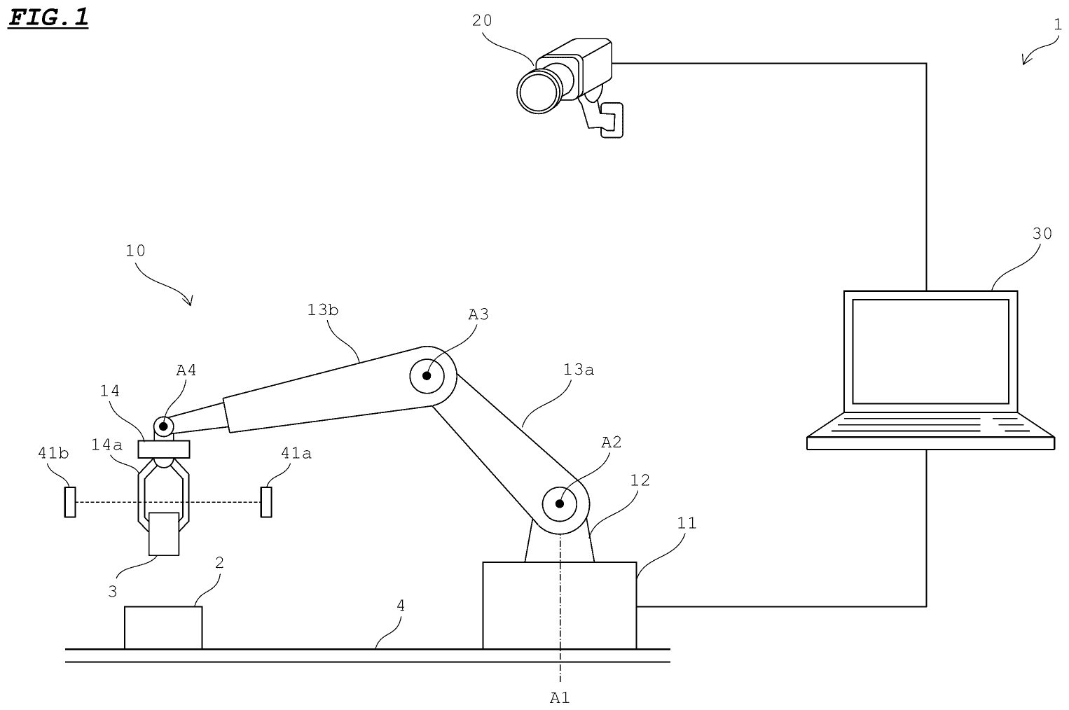

FIG. 1 schematically shows a use form of a robot monitoring system 1 according to the embodiment.

The robot monitoring system 1 monitors operation of a robot arm 10. The robot arm 10 is installed near a belt conveyor 4. The robot arm 10 transfers an article 3 placed at a predetermined position, to a container 2 on the belt conveyor 4. The robot arm 10 includes a base 11, a support 12, arms 13a, 13b, and a hand 14.

The base 11 is installed laterally to the belt conveyor 4. The support 12 is installed on the base 11 so as to be rotatable with respect to a rotation axis A1 parallel to the vertical direction. The arm 13a is installed on the support 12 so as to be rotatable with respect to a rotation axis A2 parallel to the horizontal direction. The arm 13b is installed at an end portion of the arm 13a so as to be rotatable with respect to a rotation axis A3 parallel to the horizontal direction. The hand 14 is installed at an end portion of the arm 13b so as to be rotatable with respect to a rotation axis A4 parallel to the horizontal direction. The hand 14 has a plurality of claws 14a for gripping the article 3.

The robot arm 10 includes a plurality of drive mechanisms that respectively cause the support 12, the arms 13a, 13b, and the hand 14 to rotate with respect to the rotation axes A1 to A4. The robot arm 10 can move the hand 14 in three dimensions by driving motors serving as drive sources of these drive mechanisms. The hand 14 includes a drive mechanism for opening and closing the plurality of claws 14a. The robot arm 10 can grip the article 3 and release the gripping, by driving a motor serving as a drive source of this drive mechanism.

In the robot arm 10, control commands for causing the hand 14 to operate in a predetermined operation range are set in advance. The control commands include a drive amount of each drive mechanism (motor) for moving the hand 14 from an initial position to a target position, and further, for returning the hand 14 from the target position to the initial position. More specifically, with respect to a plurality of positions (nodes) on a movement locus of the hand 14, sequentially from a node at the initial position, a drive amount of each drive mechanism (motor) for moving the hand 14 to a node is set to the node. In addition to the above control amount, the control commands include a command for opening and closing the claws 14a of the hand 14 at the above target position.

Such control commands are set by a user to the robot arm 10 through a monitoring device 30, for example. Alternatively, the above control commands may be set to the robot arm 10 through a terminal other than the monitoring device 30.

The robot monitoring system 1 includes a camera 20, the monitoring device 30, and object sensors 41a, 41b.

The camera 20 captures an image of at least the operation range of the robot arm 10. The camera 20 is installed at a position where the camera 20 can capture an overview of the robot arm 10.

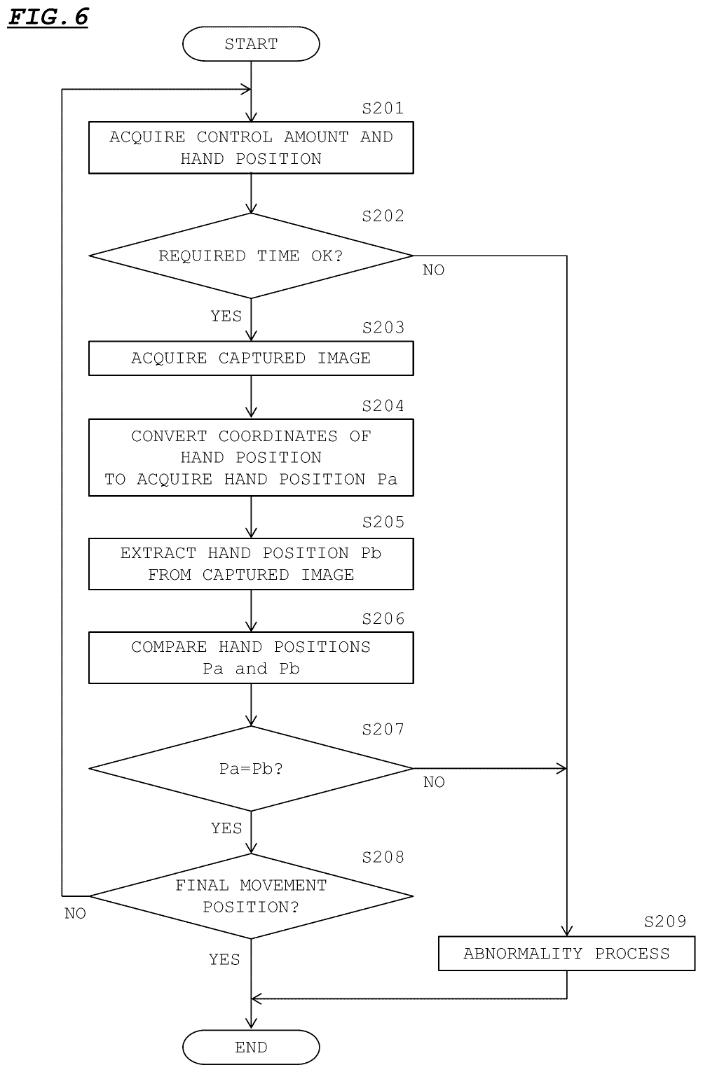

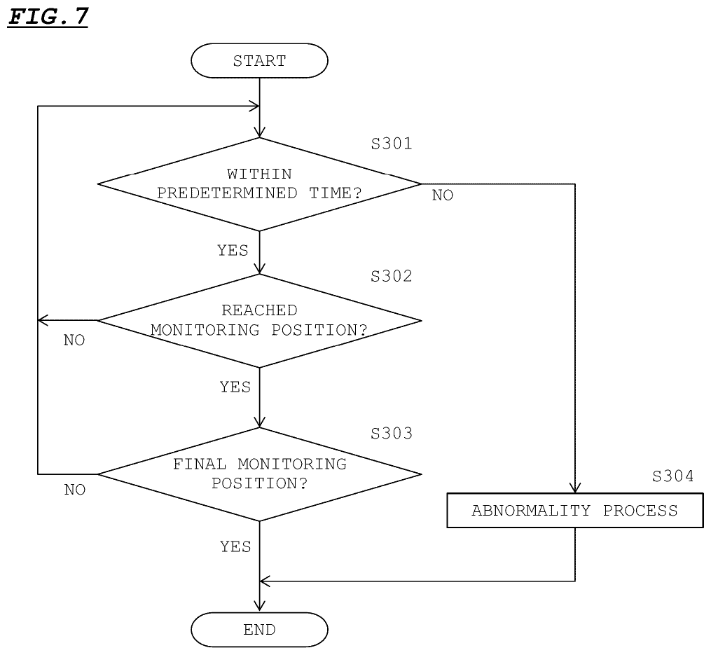

The monitoring device 30 is communicably connected to the camera 20 and the object sensors 41a, 41b through communication lines. Instead of the communication lines, communication between: the monitoring device 30; and the camera 20 and the object sensors 41a, 41b may be performed through wireless communication. The monitoring device 30 monitors the operation of the robot arm 10, based on a captured image from the camera 20 and detection results from the object sensors 41a, 41b. Monitoring control with respect to the robot arm 10 will be described later with reference to FIG. 6 and FIG. 7.

The object sensors 41a, 41b detect that the hand 14 has reached a predetermined monitoring position set in the operation range of the hand 14. The monitoring position is set at the target position described above, for example. The monitoring position is not limited to one location, and may be set at a plurality of locations in the operation range.

In the present embodiment, the object sensors 41a, 41b are implemented as infrared sensors. When the hand 14 is not present between the object sensors 41a, 41b, infrared light emitted from the object sensor 41a is received by the object sensor 41b. When the hand 14 is present between the object sensors 41a, 41b, infrared light emitted from the object sensor 41a is not received by the object sensor 41b. Therefore, depending on whether or not a signal corresponding to reception of infrared light is outputted from the object sensor 41b, whether or not the hand 14 has reached the monitoring position can be detected.

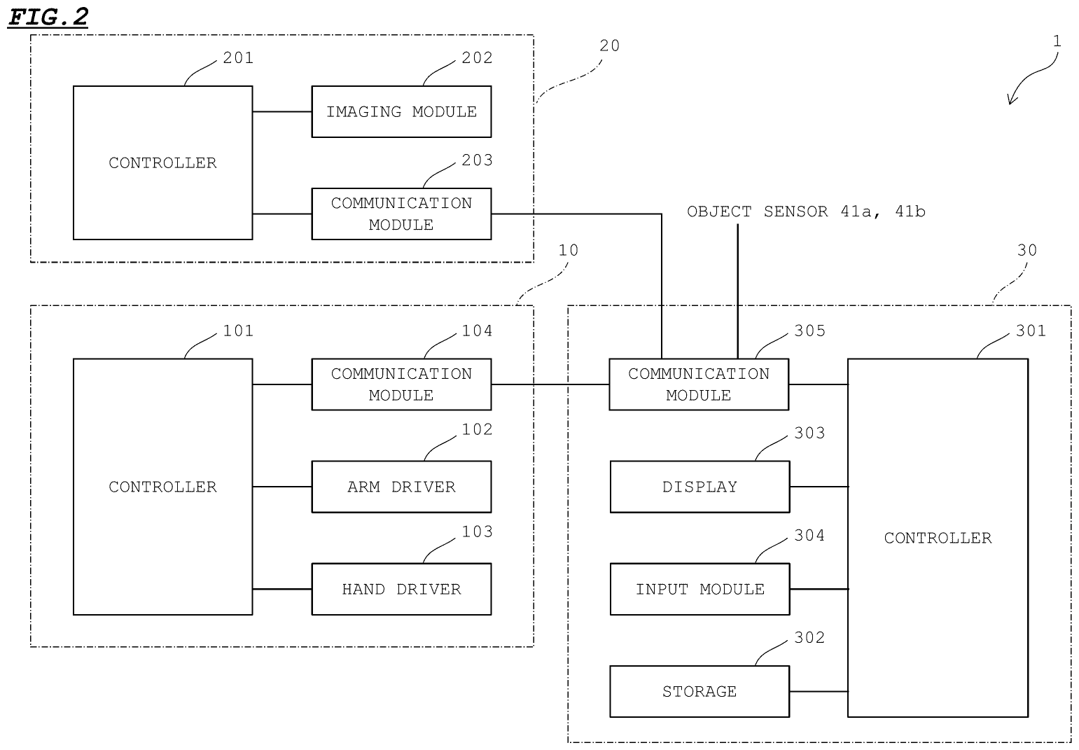

FIG. 2 is a block diagram showing configurations of the robot arm 10, the camera 20, and the monitoring device 30.

The robot arm 10 includes a controller 101, an arm driver 102, a hand driver 103, and a communication module 104.

The controller 101 includes a microcomputer and controls each component in accordance with a program stored in a built-in memory. The control commands described above are stored in a memory in the controller 101. The controller 101 may be implemented as an FPGA (Field Programmable Gate Array) or the like.

The arm driver 102 includes the motors and the drive mechanisms described above for driving the arms 13a, 13b. The hand driver 103 includes the motors and the drive mechanisms described above for driving the hand 14 and the claws 14a of the hand 14. The communication module 104 is a communication interface for performing communication with the monitoring device 30. The communication module 104 performs communication with a communication module 305 of the monitoring device 30 in accordance with control by the controller 101.

The camera 20 includes a controller 201, an imaging module 202, and a communication module 203. The controller 201 is implemented as a microcomputer or the like, for example, and controls each component in accordance with a program stored in a built-in memory. The imaging module 202 includes an imaging lens and an imaging element, and captures an image with respect to the region of the field of view in accordance with control by the controller 201. The communication module 203 is a communication interface for performing communication with the monitoring device 30. The communication module 203 performs communication with the monitoring device 30 in accordance with control by the controller 201.

The monitoring device 30 includes a controller 301, a storage 302, a display 303, an input module 304, and the communication module 305. The monitoring device 30 is implemented as a general-purpose personal computer, for example. The monitoring device 30 may be a dedicated product.

The controller 301 includes an arithmetic processing circuit such as a CPU (Central Processing Unit) and controls each component in accordance with a program stored in the storage 302. The storage 302 includes a storage medium such as a ROM, a RAM, or a hard disk, and stores a program executed by the controller 301 and various data. The storage 302 is also used as a work region when the controller 301 performs control.

The display 303 includes a display device such as a liquid crystal panel, and displays predetermined information in accordance with control by the controller 301. The input module 304 includes input means such as a mouse and a keyboard. The communication module 305 is a communication interface for performing communication with the robot arm 10, the camera 20, and the object sensors 41a, 41b. The communication module 305 performs communication with the robot arm 10, the camera 20, and the object sensors 41a, 41b in accordance with control by the controller 301.

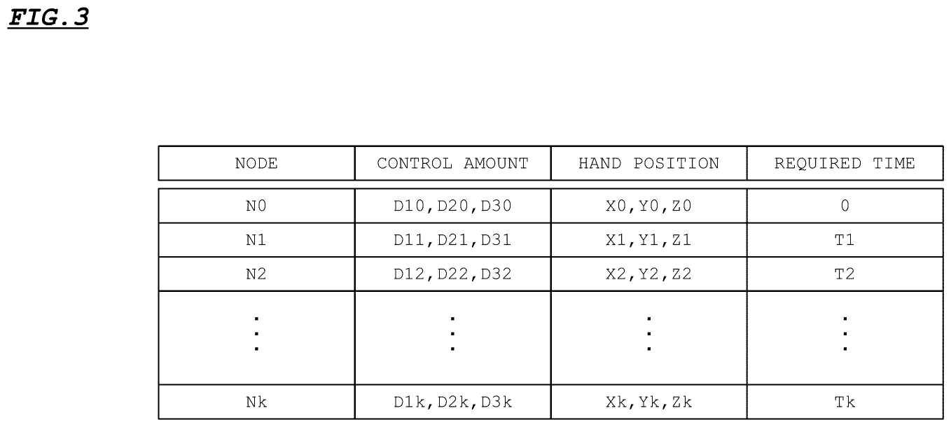

FIG. 3 shows a configuration of a table stored in the storage 302 of the monitoring device 30.

In the table, the above-described nodes set on the movement locus of the hand 14, a control amount for positioning the hand 14 at each node, a three-dimensional position (hand position) of the hand 14 when the hand 14 is positioned at each node, and a required time for the hand 14 to be positioned at each node are associated with each other.

Here, the control amount is rotation amounts by which the support 12 and the arms 13a, 13b are respectively rotated with respect to the rotation axes A1, A2, A3 in FIG. 1. Specifically, a rotation amount from the initial position of each motor serving as a drive source for the corresponding rotation is defined as the control amount. When each motor is a stepping motor, the number of steps from the initial position is defined as the corresponding control amount.

The hand position is defined as a coordinate point of a rectangular coordinate system whose origin is the installation position of the robot arm 10. The X-axis and the Y-axis of the rectangular coordinate system is parallel to a horizontal plane, and the Z-axis is parallel to the vertical direction. The origin of the rectangular coordinate system is set at the position where the upper surface of the base 11 and the rotation axis A1 in FIG. 1 cross each other, for example.

The required time is defined as a time required for the hand 14 to reach each node from the initial position during normal operation. That is, when the robot arm 10 has moved without its operation being restricted by an unexpected obstacle or the like, the time required for the hand 14 to reach each node from the initial position is the required time defined for the node.

During normal operation, the hand 14 moves from the first node N0 to nodes N1, N2, . . . , Nk in accordance with the control commands described above. In the table, a movement position to which the hand 14 sequentially moves during normal operation of the hand 14, and a required time to that position are defined.

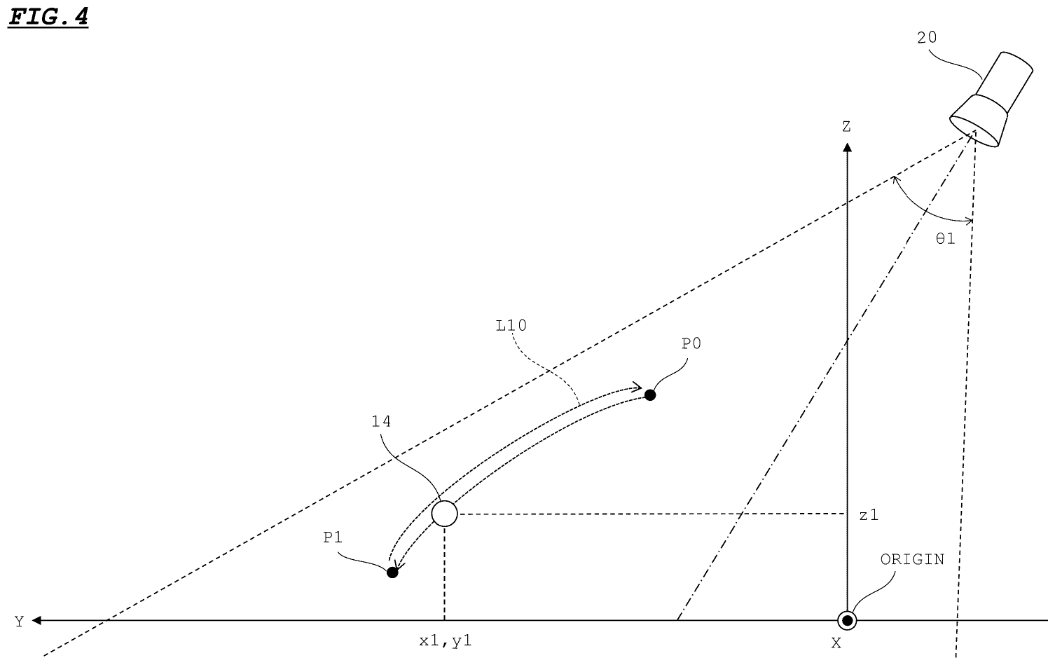

FIG. 4 schematically shows a relationship between the field of view of the camera 20 and the rectangular coordinate system of the robot arm 10.

As shown in FIG. 4, the camera 20 is installed such that the origin of the rectangular coordinate system is included in a range of a viewing angle θ of the camera 20. In addition, the camera 20 is installed such that an operation locus L10 (operation range) of the hand 14 is included in the range of this viewing angle θ. The hand 14 moves from an initial position P0 to a target position P1, and further, returns from the target position P1 to the initial position P0. In FIG. 4, the position of the hand 14 is (x1, y1, z1).

Before performing monitoring operation, the controller 301 of the monitoring device 30 executes a calibration process for associating each coordinate point (X coordinate, Y coordinate, Z coordinate) of the rectangular coordinate system, with a corresponding pixel position on a captured image from the camera 20, based on the installation position of the camera 20, the imaging direction (orientation of the optical axis) and viewing angle of the camera 20, and the origin position of the rectangular coordinate system. That is, a ray of light incident on a pixel is different for each pixel. Therefore, a coordinate point present on a ray of light incident on one pixel is associated with the pixel position of the one pixel. Each pixel is associated with a plurality of coordinate points present on the ray of light corresponding to the pixel.

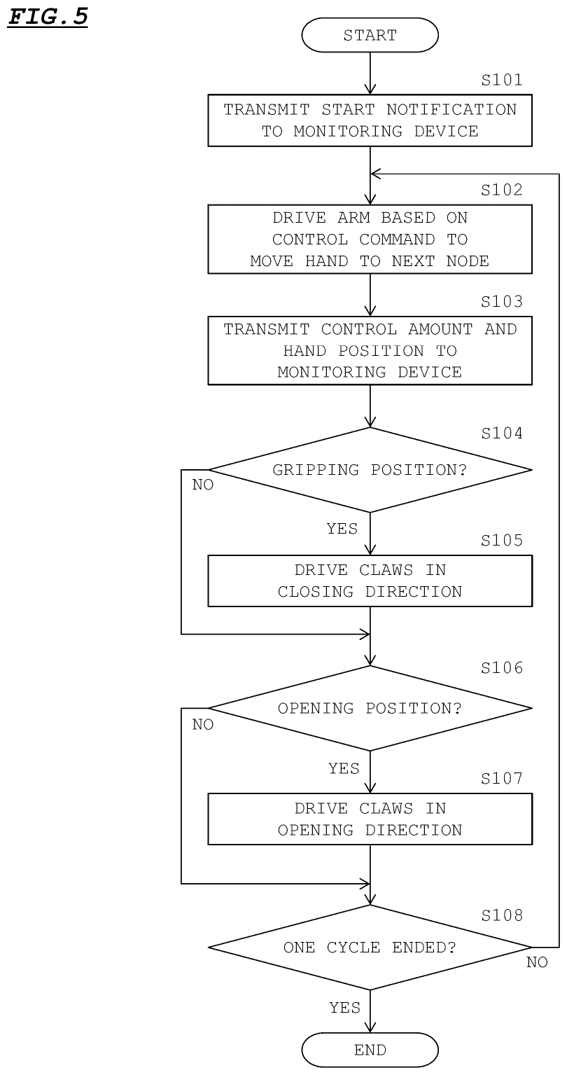

FIG. 5 is a flowchart showing a process performed by the controller 101 during actual operation of the robot arm 10.

When the actual operation has started, first, the controller 101 transmits a start notification to the monitoring device 30 via the communication module 104 (S101). Next, the controller 101 drives the arms 13a, 13b, based on the control commands described above to move the hand 14 to the next node (S102). Upon completion of the movement of the hand 14, the controller 101 transmits the above control amount for moving the hand 14 to the node after the movement, and a coordinate value in the rectangular coordinate system of the node, to the monitoring device 30 via the communication module 104 (S103).

When the node after the movement is a gripping position (S104: YES), the controller 101 drives the claws 14a of the hand 14 in a closing direction (S105). When the node after the movement is a position where the gripping is released (S106: YES), the controller 101 drives the claws 14a of the hand 14 in an opening direction (S107). Then, the controller 101 determines whether or not the process has ended for all of the nodes (S108). When the determination in step S108 is NO, the controller 101 returns the process to step S102 to perform the process for the next node. Then, when the process of one cycle has ended (S108: YES), the controller 101 ends the process in FIG. 5.

FIG. 6 is a flowchart showing a monitoring process performed in the controller 301 of the monitoring device 30.

When the controller 301 has received the control amount and the hand position transmitted in step S103 in FIG. 5 (S201), the controller 301 determines whether or not the actual required time required from the reception of the start notification transmitted in step S101 in FIG. 5 to the reception of these pieces of information has exceeded a reference required time defined in the table in FIG. 3 (S202). More specifically, the controller 301 extracts, from the table in FIG. 3, a required time (reference required time) corresponding to the control amount and the hand position received in step S201, and compares the extracted required time with the actual required time. Then, when the difference (time difference) between these does not exceed a threshold defining an allowable error (a possible time deviation that is assumed to occur during normal operation), the controller 301 sets the determination in step S202 to YES, and when the time difference between these exceeds this threshold, the controller 301 sets the determination in step S202 to NO.

When the determination in step S202 is NO, the controller 301 executes an abnormality process, considering that some abnormality has occurred in driving of the robot arm 10 (S209). In this abnormality process, the controller 301 executes an emergency stop of the operation of the robot arm 10, for example, and causes the display 303 to display a screen for announcing an abnormality.

When the robot arm 10 has come into contact with an unexpected obstacle, a certain load is applied on the robot arm 10. Accordingly, the movement speed of the robot arm 10 decreases as compared with that during normal operation, or the robot arm 10 may enter a substantially stopped state. When the movement speed of the robot arm 10 has decreased as compared with that during normal operation, the determination result in step S202 becomes NO, and the abnormality process in step S209 is executed.

Meanwhile, when the robot arm 10 has entered a substantially stopped state due to the above-described contact with an obstacle, the robot arm 10 does not complete movement to the next node, and thus, cannot transmit the control amount and the hand position to the monitoring device 30. Therefore, also when the controller 301 of the monitoring device 30 does not receive the control amount and the hand position for a predetermined time or more in step S201, the controller 301 sets the determination in step S202 to NO. More specifically, even though a predetermined time has elapsed after the controller 301 has received the control amount and the hand position through the process in step S201 in the previous time, if the controller 301 does not receive the control amount and the hand position in current step S201, the controller 301 sets the determination in step S202 to NO, and executes the abnormality process in step S209.

When the determination in step S202 is YES, the controller 301 advances the process to step S203, and executes a monitoring process based on a captured image acquired from the camera 20. In this monitoring process, first, the controller 301 acquires a captured image captured by the camera 20 at substantially the same timing as the timing of the reception of the control amount and the hand position (S203). Here, the controller 301 receives captured images as appropriate from the camera 20, and temporarily stores the received captured images in the storage 302. In step S203, the controller 301 extracts, out of the captured images temporarily stored in the storage 302, a captured image received at substantially the same timing as the timing of the reception of the control amount and the hand position in step S201.

Next, the controller 301 acquires a hand position Pa on a captured image corresponding to the hand position acquired in step S201, based on the association defined by the calibration process described above (S204). In addition, the controller 301 extracts a hand position Pb from the captured image acquired in step S203 (S205). In step S205, the controller 301 executes, on the captured image, an image analysis process for extracting the contour of the region of the hand 14, for example. In this case, the controller 301 extracts the center of gravity of the extracted region, as the hand position Pb. Alternatively, in a case where a marker has been provided to the hand 14, the controller 301 extracts the marker from the captured image, and extracts the center of the extracted marker, as the hand position Pb. The marker can be a label having a specific color such as red, for example.

After having acquired the two hand positions Pa, Pb in this manner, the controller 301 compares these two hand positions Pa, Pb with each other (S206), and determines whether or not these hand positions Pa, Pb are substantially the same position on the captured image (S207). In step S207, the controller 301 calculates a positional deviation amount between these two hand positions Pa, Pb, and determines whether or not the calculated positional deviation amount is in a range of an allowable error (a possible deviation amount that can be assumed to occur during normal operation). When the positional deviation amount is in the range of this error, the controller 301 sets the determination in step S207 to YES. When the positional deviation amount is not in the range of this error, the controller 301 sets the determination in step S207 to NO.

When the determination in step S207 is NO, the controller 301 executes the abnormality process in step S209 and ends the process in FIG. 6. When the determination in step S207 is YES, the controller 301 determines whether or not the hand 14 has reached the final movement position, that is, the last node Nk shown in FIG. 3 (S208). When the hand 14 has not reached the final movement position, the controller 301 returns the process to step S201, and receives the subsequent control amount and hand position from the robot arm 10. Then, the controller 301 executes the same processes as above (S202 to S209). Then, when the hand 14 has reached the final movement position, without the abnormality process being executed in step S209, (S208: YES), the controller 301 ends the process in FIG. 6.

FIG. 7 is a flowchart showing another monitoring process performed in the controller 301 of the monitoring device 30.

The controller 301 continuously refers to detection signals received from the object sensors 41a, 41b, and determines whether or not the hand 14 has reached the monitoring position within a predetermined time from the start of operation of the robot arm 10 (S301, S302). Here, the predetermined time is set to a time required for the hand 14 to reach the monitoring position when the robot arm 10 normally operates.

When the hand 14 has not reached the monitoring position within the predetermined time (S301: NO), the controller 301 executes the same abnormality process as that in step S209 in FIG. 6 (S304). When the hand 14 has reached the monitoring position within the predetermined time (S301: YES, S302: YES), the controller 301 determines whether or not the monitoring position at this time is the final monitoring position (S303). When the monitoring position at this time is not the final monitoring position (S303: NO), the controller 301 returns the process to step S301 and executes the same process with respect to the next monitoring position. Then, when having performed the process up to the final monitoring position (S303: YES), the controller 301 ends the process in FIG. 7.

### Effects of the Embodiment

According to the above embodiment, the following effects are exhibited.

As shown in FIG. 6, the controller 301 executes: a process (S203 to S207: first determination process) of determining an operational abnormality of the robot arm 10 by comparing an operation position of the hand 14 (monitoring target) acquired from the robot arm 10 via the communication module 305 with an operation position of the hand 14 (monitoring target) based on a captured image acquired from the camera 20 via the communication module 305; and a process (S202: second determination process) of determining an operational abnormality of the robot arm 10 by comparing a timing when the operation position has been acquired from the robot arm 10 via the communication module 305 with a timing based on time information (required time) associated with the operation position in the table in FIG. 3.

Accordingly, through the process (S203 to S207: first determination process) using a captured image of the robot arm 10, an operational abnormality of the robot arm 10 can be determined. Even when occlusion of the hand 14 (monitoring target) of the robot arm 10 has occurred in this captured image, an operational abnormality of the robot arm 10 can be determined through the process (S202: second determination process) using the time information (required time) regarding the timing when the hand 14 (monitoring target) is positioned at each of the operation positions. Therefore, an operational abnormality of the robot arm 10 can be determined appropriately and assuredly.

As shown in FIG. 3, the table holds, as the time information, a required time for the hand 14 (monitoring target) to reach each of the operation positions from the initial position (reference position). The controller 301 determines, in step S202 (second determination process) in FIG. 6, an operational abnormality of the robot arm 10, based on whether or not the difference between a required time up to the timing when the operation position has been acquired from the robot arm 10 and a required time associated with the operation position in the table exceeds a predetermined threshold. Accordingly, in a case where the movement speed of the robot arm 10 has decreased or the robot arm 10 has become unable to move any more since the robot arm 10 has come into contact with some obstacle or the like, the determination in step S202 becomes NO, and an operational abnormality of the robot arm 10 is determined. Therefore, an operational abnormality of the robot arm 10 can be appropriately determined.

As shown in FIG. 7, the controller 301 further executes a process (S301, S302: third determination process) of determining an operational abnormality of the robot arm 10, based on whether or not a detection result indicating that the hand 14 (monitoring target) has reached the monitoring position within a predetermined time after start of operation of the hand 14 (monitoring target) has been obtained from the object sensors 41a, 41b. Accordingly, for example, also when the monitoring device 30 has not been able to appropriately receive the operation position (hand position) from the robot arm 10 due to communication failure or the like, an operational abnormality of the robot arm 10 can be appropriately determined through the process in FIG. 7.

In steps S203 to S207 (first determination process) in FIG. 6, the controller 301 converts the operation position of the hand 14 (monitoring target) acquired from the robot arm 10 via the communication module 305 into an operation position on a captured image, and compares the converted operation position with the operation position of the hand 14 (monitoring target) based on the captured image, to determine an operational abnormality of the robot arm 10. Accordingly, an operational abnormality of the robot arm 10 can be appropriately determined through a simple process.

### Modification

Although the embodiment of the present invention has been described above, the present invention is not limited to the above embodiment, and the embodiment of the present invention can also be modified as appropriate other than the above.

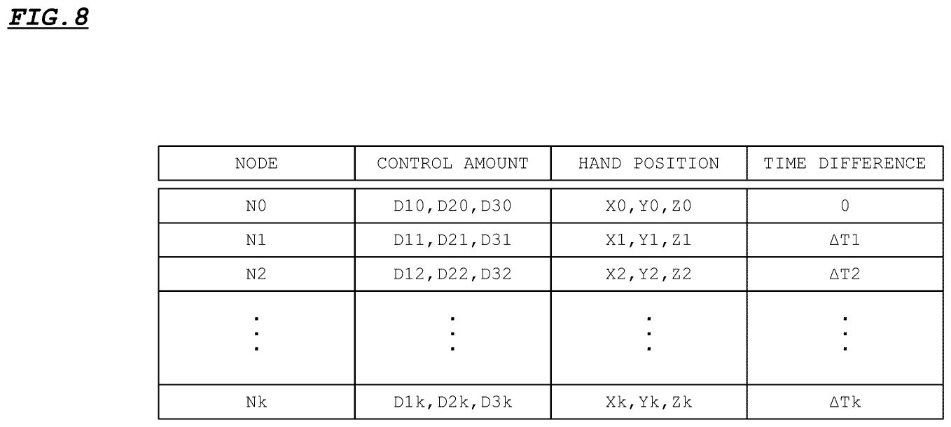

For example, in the above embodiment, the table shown in FIG. 3 is used in the determination process (second determination process) in step S202 in FIG. 6. However, a table having another configuration may be used in the determination process (second determination process) in step S202. For example, as shown in FIG. 8, as the time information associated with each node (operation position), the time difference between the timing when the hand 14 (monitoring target) reaches one node (operation position) and the timing when the hand 14 (monitoring target) reaches a node (operation position) immediately preceding the one node (operation position) may be held.

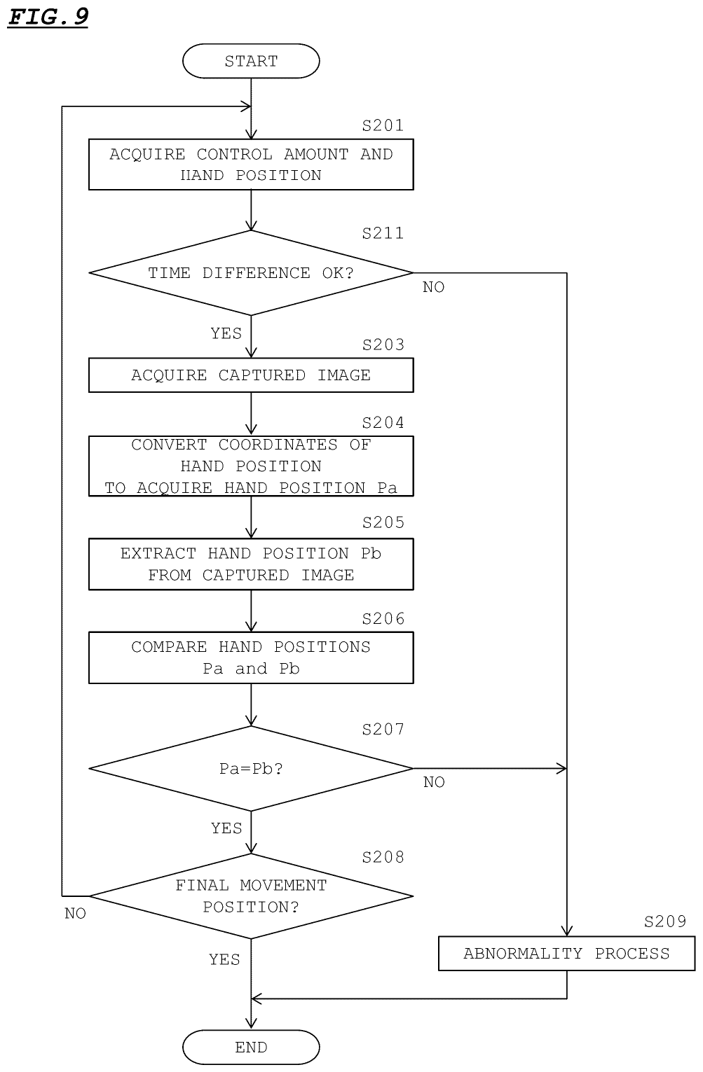

In this case, as shown in FIG. 9, the controller 301 executes a process of step S211 instead of step S202 in FIG. 6. In step S211, the controller 301 determines an operational abnormality of the robot arm 10, based on the time required for the hand 14 (monitoring target) to move from a hand position (operation position) corresponding to an immediately preceding node to a hand position (operation position) corresponding to the node at this time, that is, whether or not the time difference between the reception timing in step S201 in the previous time and the reception timing in step S201 at this time exceeds a time difference associated with the hand position (operation position) at this time in the table in FIG. 8.

In this case as well, similar to step S202 in FIG. 6, in a case where the movement speed of the robot arm 10 has decreased or the robot arm 10 has become unable to move any more since the robot arm 10 has come into contact with some obstacle or the like, the determination in step S211 becomes NO, and an operational abnormality of the robot arm 10 is determined. Therefore, an operational abnormality of the robot arm 10 can be appropriately determined.

In the above embodiment, a single camera 20 captures an overview of the robot arm 10. However, two or more cameras 20 may capture overviews of the robot arm 10. In this case, captured images acquired by the plurality of the cameras 20 may be subjected to a stereo matching process (stereo corresponding point searching process), to further acquire the distance to the hand 14 (monitoring target).

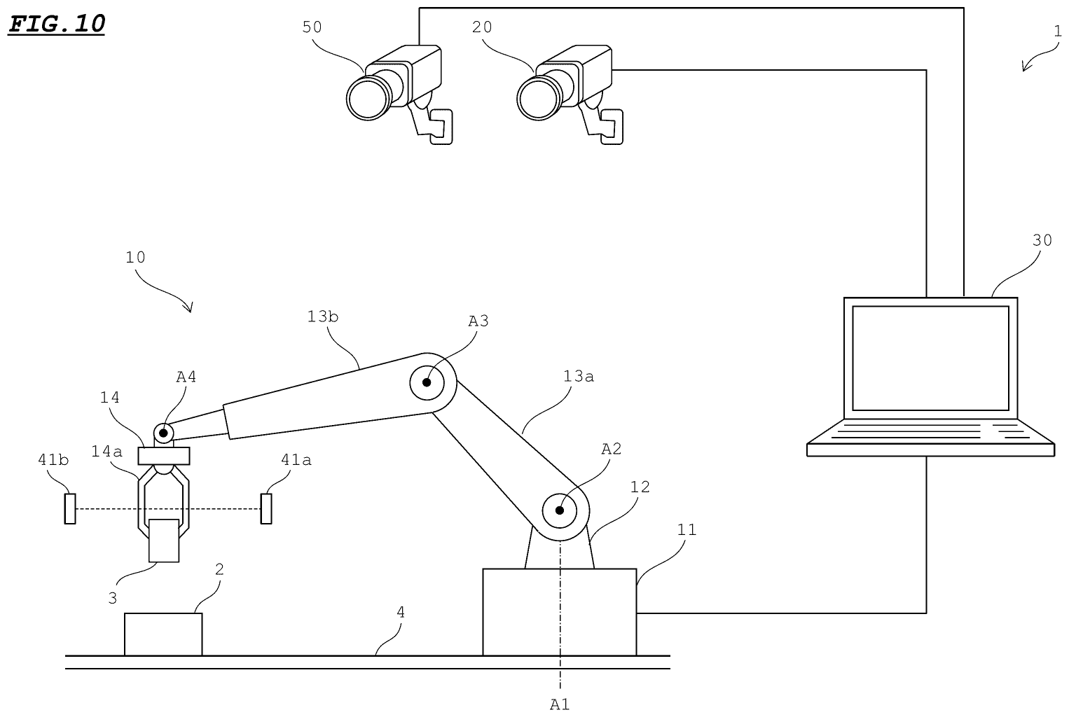

For example, as shown in FIG. 10, two cameras 20, 50 may capture overviews of the robot arm 10. Then, the parallax (pixel deviation amount) of the hand 14 (monitoring target) in the captured images from the cameras 20, 50 may be detected, and from this parallax, the distance from the camera 20 to the hand 14 (monitoring target) may be detected by a triangulation method. In this case, the camera 50 is further included in the robot monitoring system 1.

Thus, if the distance to the hand 14 (monitoring target) is acquired, the three-dimensional position of the hand 14 (monitoring target) can be acquired. Therefore, in this case, a calibration process of associating the three-dimensional position acquired from the captured images with a three-dimensional position in the rectangular coordinate system set in the robot arm 10 may be performed.

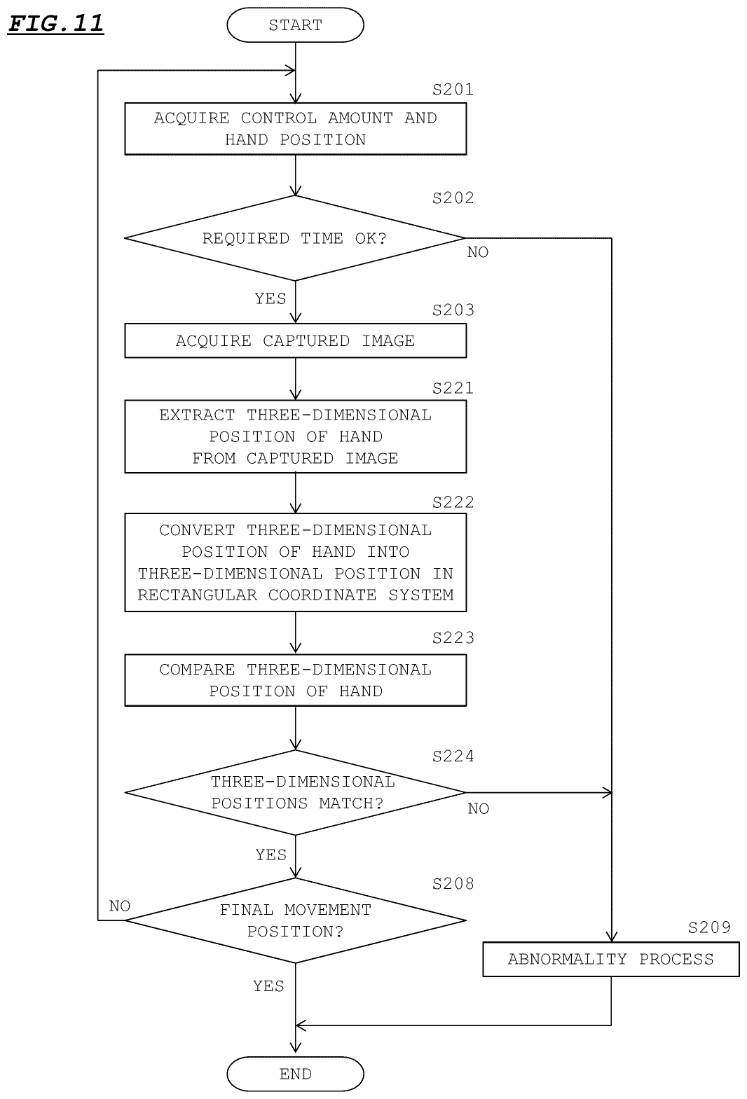

In this case, instead of steps S204 to S207 in FIG. 9, processes of steps S221 to S224 in FIG. 11 are performed. In step S221, using the captured image from the camera 50 as a reference image, the controller 301 executes the stereo corresponding point searching process between the captured image from the camera 20 and the reference image.

More specifically, the controller 301 sections the captured image from the camera 20 into pixel blocks having a predetermined size (e.g., a pixel block of 3 vertically×3 horizontally), and sets one of the sectioned pixel blocks as a pixel block (target pixel block) to be processed. The controller 301 searches for, on the reference image, a pixel block (matching pixel block) that matches (having the highest correlation between pixel values of pixels) the target pixel block. The correlation is calculated according to SAD (Sum of Absolute Difference), SSD (Sum of Squared Difference), or the like. A search range is set in the direction of separation between cameras 20, 50, using the pixel block on the reference image at the same position as the target pixel block as a reference position, for example.

The controller 301 extracts the pixel deviation amount between the reference position and the matching pixel block as a parallax, and from this parallax, calculates a distance to each component of the robot arm 10 by the triangulation method. The controller 301 executes the above process on all of the pixel blocks on the captured image from the camera 20, and generates a distance image in which each pixel block and a distance are associated with each other. The controller 301 acquires a three-dimensional position of the hand 14 (monitoring target) from the position of the hand 14 (monitoring target) on the distance image.

In step S222, the controller 301 converts the acquired three-dimensional position of the hand 14 (monitoring target) into a three-dimensional position in the rectangular coordinate system of the robot arm 10. That is, the controller 301 converts the three-dimensional position composed of the distance and the direction corresponding to the pixel position of the hand 14, into a three-dimensional position in the rectangular coordinate system of the robot arm 10. In step S223, the controller 301 compares the converted three-dimensional position with the hand position acquired from the robot arm 10 in step S201.

In step S224, the controller 301 determines whether or not the converted three-dimensional position and the hand position (three-dimensional position) acquired from the robot arm 10 are substantially the same with each other. That is, the controller 301 determines whether or not the difference between these two three-dimensional positions exceeds a predetermined threshold (a possible difference assumed to occur during normal operation). When this difference does not exceed the threshold (S224: YES), the controller 301 advances the process to step S208, and when this difference exceeds this threshold (S224: NO), the controller 301 advances the process to step S209.

In steps S203 and S221 to S224 (first determination process), the controller 301 converts the operation position of the monitoring target based on the captured image into an operation position in the rectangular coordinate system of the robot arm 10, and compares the converted operation position with the operation position of the hand 14 (monitoring target) acquired from the robot arm 10 via the communication module 305, to determine an operational abnormality of the robot arm 10. Thus, through comparison between the three-dimensional positions of the hand 14 (monitoring target), an operational abnormality of the robot arm 10 can be more appropriately determined.

Alternatively, instead of the camera 50 in FIG. 10, a projection device that applies pattern light having a specific pattern (intensity distribution) in the operation range of the robot arm 10 may be disposed, and the distance of the hand 14 (monitoring target) may be detected from a captured image, from the camera 20, of the robot arm 10 to which the pattern light is applied. In this case, the projection device is further included in the robot monitoring system 1.

In this case, a reference image in which the above pattern is distributed is held in the storage 302 of the monitoring device 30. The controller 301 of the monitoring device 30 searches for, on the reference image, a pixel block having the highest correlation to the target pixel block on the captured image. The search range is set in the direction of separation between the camera 20 and the projection device, using the same position as the target pixel block as a reference position, for example. The controller 301 detects the pixel deviation amount between the pixel block extracted through the search and the reference position, as a parallax. From this parallax, the controller 301 calculates the distance to the hand 14 (monitoring target) by the triangulation method.

In the above embodiment, a single camera 20 captures an image of the operation range of a single robot arm 10. However, a single camera 20 may capture an image of the operation ranges of a plurality of the robot arms 10. In this case, the monitoring device 30 may divide the captured image from the camera 20 into regions of the respective robot arms 10, to monitor the operation of each robot arm 10.

In the above embodiment, the monitoring control in FIG. 7 is executed in parallel with the monitoring control in FIG. 6. However, the monitoring control in FIG. 7 may be omitted. In this case, the object sensors 41a, 41b can be omitted from the configuration in FIG. 1. Further, instead of the monitoring control in FIG. 7, or alternatively, together with the monitoring control in FIG. 7, another monitoring control different from the monitoring control in FIG. 6 may be performed.

In the above embodiment, the robot arm 10 having the configuration shown in FIG. 1 is monitored by the robot monitoring system 1. However, the configuration of the robot arm 10 to be monitored is not limited to the configuration in FIG. 1. For example, the number of arms that can bend is not limited to two, and another number may be adopted. The configuration for holding the article 3 is not limited to the configuration of clamping by the claws 14a, and a configuration for suctioning using a negative pressure may be adopted. An object sensor other than an infrared sensor may be used. Further, the robot to be monitored by the robot monitoring system 1 is not limited to the robot arm 10, and may be another type of robot.

In addition to the above, various modifications can be made as appropriate to the embodiment of the present invention without departing from the scope of the technical idea defined by the claims.

What is claimed is:

1. A robot monitoring system comprising:
a camera configured to capture an image of at least an operation range of a robot; and
a monitoring device configured to monitor operation of the robot, based on a captured image from the camera, wherein
the monitoring device includes
a storage,
a controller, and
a communication module configured to perform communication with the robot and the camera,
the storage stores a table in which a series of operation positions to which a monitoring target of the robot moves and time information regarding a timing when the monitoring target is positioned at each of the operation positions are associated with each other, and
the controller executes
a first determination process of determining an operational abnormality of the robot by comparing an operation position of the monitoring target acquired from the robot via the communication module with an operation position of the monitoring target based on the captured image acquired from the camera via the communication module, and
a second determination process of determining an operational abnormality of the robot by comparing a timing when the operation position has been acquired from the robot via the communication module with a timing based on the time information associated with the operation position in the table.

2. The robot monitoring system according to claim 1, wherein
the table holds, as the time information, a required time for the monitoring target to reach each of the operation positions from a predetermined reference position, and
the controller determines, in the second determination process, an operational abnormality of the robot, based on whether or not a difference between a required time up to the timing when the operation position has been acquired from the robot and the required time associated with the operation position in the table exceeds a predetermined threshold.

3. The robot monitoring system according to claim 1, wherein
the table holds, as the time information, a time difference between a timing when the monitoring target reaches one of the operation positions and a timing when the monitoring target reaches the operation position immediately preceding the one operation position, and
the controller determines, in the second determination process, an operational abnormality of the robot, based on whether or not a time required for the monitoring target to move from the immediately preceding operation position to the operation position exceeds the time difference associated with the operation position in the table.

4. The robot monitoring system according to claim 1, comprising
an object sensor configured to detect that the monitoring target has reached a monitoring position in the operation range, wherein
the controller further executes a third determination process of determining an operational abnormality of the robot, based on whether or not a detection result indicating that the monitoring target has reached the monitoring position has been obtained from the object sensor within a predetermined time after start of operation of the monitoring target.

5. The robot monitoring system according to claim 1, wherein
in the first determination process, the controller converts the operation position of the monitoring target acquired from the robot via the communication module, into an operation position on the captured image, and compares the converted operation position with the operation position of the monitoring target based on the captured image, to determine an operational abnormality of the robot.

6. The robot monitoring system according to claim 1, wherein
in the first determination process, the controller converts the operation position of the monitoring target based on the captured image into an operation position in a rectangular coordinate system of the robot, and compares the converted operation position with the operation position of the monitoring target acquired from the robot via the communication module, to determine an operational abnormality of the robot.

7. A monitoring device configured to monitor operation of a robot, the monitoring device comprising:
a storage;
a controller; and
a communication module configured to perform communication with the robot and a camera configured to capture an image of at least an operation range of the robot, wherein
the storage stores a table in which a series of operation positions to which a monitoring target of the robot moves and time information regarding a timing when the monitoring target is positioned at each of the operation positions are associated with each other, and
the controller executes
a first determination process of determining an operational abnormality of the robot by comparing an operation position of the monitoring target acquired from the robot via the communication module with an operation position of the monitoring target based on a captured image acquired from the camera via the communication module, and
a second determination process of determining an operational abnormality of the robot by comparing a timing when the operation position has been acquired from the robot via the communication module with a timing based on the time information associated with the operation position in the table.

8. A method for controlling a monitoring device configured to monitor operation of a robot,
the monitoring device storing a table in which a series of operation positions to which a monitoring target of the robot moves and time information regarding a timing when the monitoring target is positioned at each of the operation positions are associated with each other,
the method comprising the steps of:
acquiring an operation position of the monitoring target from the robot via a communication module;
acquiring a captured image via the communication module from a camera configured to capture an image of at least an operation range of the robot;
determining an operational abnormality of the robot by comparing the operation position of the monitoring target acquired from the robot with an operation position of the monitoring target based on the captured image acquired from the camera; and
determining an operational abnormality of the robot by comparing a timing when the operation position has been acquired from the robot with a timing based on the time information associated with the operation position in the table.

9. A non-transitory tangible storage medium having stored therein a program configured to cause a controller, of a monitoring device configured to monitor operation of a robot, to execute predetermined functions,
the program including a table in which a series of operation positions to which a monitoring target of the robot moves and time information regarding a timing when the monitoring target is positioned at each of the operation positions are associated with each other,
the program causing the controller to execute:
a function of acquiring an operation position of the monitoring target from the robot via a communication module;
a function of acquiring a captured image via the communication module from a camera configured to capture an image of at least an operation range of the robot;
a function of determining an operational abnormality of the robot by comparing the operation position of the monitoring target acquired from the robot with an operation position of the monitoring target based on the captured image acquired from the camera; and
a function of determining an operational abnormality of the robot by comparing a timing when the operation position has been acquired from the robot with a timing based on the time information associated with the operation position in the table.
